(19) United States
(12) Patent Application Publication
(10) Pub. No.: US 2022/0102808 A1
(43) Pub. Date: Mar. 31, 2022

(54) NON-AQUEOUS ELECTROLYTE SECONDARY BATTERY

(71) Applicant: Panasonic Intellectual Property Management Co., Ltd., Osaka-shi, Osaka (JP)

(72) Inventors: Masanori Sugimori, Osaka (JP); Yasunori Baba, Hyogo (JP); Katsunori Yanagida, Hyogo (JP); Nobuhiro Hirano, Osaka (JP)

(73) Assignee: Panasonic Intellectual Property Management Co., Ltd., Osaka-shi, Osaka (JP)

(21) Appl. No.: 17/430,155

(22) PCT Filed: Jan. 27, 2020
(86) PCT No.: PCT/JP2020/002827

§ 371 Date: Aug. 11, 2021

(30) Foreign Application Priority Data
Feb. 28, 2019 (JP) 2019-036512

(51) Int. Cl. H01M 50/431; H01M 50/443; H01M 50/426

(52) U.S. Cl. CPC H01M 50/431; H01M 50/426; H01M 50/443

(57) ABSTRACT

A separator for use in a non-aqueous electrolyte secondary battery according to the present invention comprises a porous substrate and a filler layer disposed upon the substrate. The filler layer includes phosphate particles and inorganic particles having a higher heat resistance than the phosphate particles. The D10 particle size (D₁₀) of the phosphate particles on a volume basis is 0.02 μm to 0.5 μm, inclusive, and is smaller than the average pore size of the pores in the substrate. The BET specific surface area of the phosphate particles is 5 m²/g to 100 m²/g, inclusive, and is greater than the BET specific surface area of the inorganic particles. The D50 particle size (D₅₀) of the inorganic particles on a volume basis is greater than the D50 particle size (D₅₀) of the phosphate particles on a volume basis.

### TECHNICAL FIELD

The present disclosure relates to a non-aqueous electrolyte secondary battery.

### BACKGROUND

In a non-aqueous electrolyte secondary battery, heat may be generated when abnormality occurs such as excessive charging, internal short-circuiting, external short-circuiting, excessive resistive heating due to a large current, or the like. In the related art, as a technique for suppressing an increase in temperature when abnormality occurs in the non-aqueous electrolyte secondary battery, there is known a shutdown function of the separator. The shutdown function is a function in which the separator is melted by the heat and pores of the separator are thus filled. When abnormality occurs in the battery, for example, ion conduction (movement of lithium ions) between positive and negative electrodes are blocked by the shutdown function, and the increase in the battery temperature can thus be suppressed.

### CITATION LIST

### Patent Literature

Patent Literature 1: WO 2012/137376

Patent Literature 2: CN 107737702 A

### SUMMARY

In recent years, in response to a demand for higher capacity of the battery, reduction of a thickness of the separator has been considered. However, when the thickness of the separator is reduced, the separator may deform or contract when abnormality occurs in the battery, resulting in difficulty in realizing the shutdown function, and, consequently, difficulty in suppression of the increase of the battery temperature.

An advantage of the present disclosure lies in provision of a non-aqueous electrolyte secondary battery in which an increase in a battery temperature can be suppressed when abnormality occurs in the battery.

According to one aspect of the present disclosure, there is provided a non-aqueous electrolyte secondary battery including: an electrode element having a positive electrode, a negative electrode, and a separator; and a non-aqueous electrolyte, wherein the separator includes a porous base member, and a filler layer placed over the base member, the filler layer includes phosphate particles and inorganic particles having a higher thermal endurance than the phosphate particles, a volume-based 10% particle size (D₁₀) of the phosphate particles is greater than or equal to 0.02 μm and less than or equal to 0.5 μm, and is smaller than an average pore size of the base member, a BET specific surface area of the phosphate particles is greater than or equal to 5 m²/g and less than or equal to 100 m²/g, and is greater than a BET specific surface area of the inorganic particles, and a volume-based 50% particle size (D₅₀) of the inorganic particles is greater than a volume-based 50% particle size (D₅₀) of the phosphate particles.

According to an aspect of the present disclosure, a non-aqueous electrolyte secondary battery can be provided in which the increase in the battery temperature when abnormality occurs in the battery can be suppressed.

### BRIEF DESCRIPTION OF DRAWINGS

FIG. 1 is a perspective diagram of a non-aqueous electrolyte secondary battery according to an embodiment of the present disclosure.

FIG. 2 is a partially enlarged cross-sectional view showing an example of an electrode element used in the non-aqueous electrolyte secondary battery of FIG. 1.

FIG. 3 is a partially enlarged plan view of a filler layer for explaining a state of polyvinylidene fluoride of a mesh form.

### DESCRIPTION OF EMBODIMENTS

A non-aqueous electrolyte secondary battery according to an embodiment of the present disclosure comprises: an electrode element having a positive electrode, a negative electrode, and a separator; and a non-aqueous electrolyte, wherein the separator comprises a porous base member, and a filler layer placed over the base member, the filler layer includes phosphate particles and inorganic particles having a higher thermal endurance than the phosphate particles, a volume-based 10% particle size (D₁₀) of the phosphate particles is greater than or equal to 0.02 μm and less than or equal to 0.5 μm, and is smaller than an average pore size of the base member, a BET specific surface area of the phosphate particles is greater than or equal to 5 m²/g and less than or equal to 100 m²/g, and is greater than a BET specific surface area of the inorganic particles, and a volume-based 50% particle size (D₅₀) of the inorganic particles is greater than a volume-based 50% particle size (D₅₀) of the phosphate particles.

In general, a porous base member has a shutdown function in which the porous base member is melted by heat generated when abnormality occurs in the battery, to thereby fill pores of the porous base member. In the present disclosure, this shutdown function of the separator is further improved as the phosphate particles included in the filler layer melt and polymerize with the heat as an accelerating factor by the heat caused by the abnormality of the battery, and the pores of the porous base member are thereby filled. In particular, with the particle size and the BET specific surface area of the phosphate particles in the above-described ranges, the phosphate particles tend to easily melt by the heat generated when the abnormality occurs in the battery, and the pores of the porous base member can be quickly filled. In addition, when the porous base member deforms or contracts due to heat generated when abnormality occurs in the battery, the shutdown function of the separator may become insufficient. In the present disclosure, because the filler layer includes the inorganic particles having a higher thermal endurance than the phosphate particles, the filler layer has a high thermal endurance. In particular, a filler layer including the inorganic particles having the particle size and the BET specific surface area defined above have a sufficiently high thermal endurance. Therefore, a state is realized in which the porous base member is supported by the filler layer with the high thermal endurance, and thus, when abnormality occurs in the battery, the deformation and contraction of the porous base member can be suppressed, and the shutdown function of the separator can be maintained. Because of this, when the abnormality occurs in the battery, for example, the movement of the lithium ions between the positive and negative electrodes can be quickly blocked by the separator, and the heat generation reaction can be sufficiently suppressed, and, as a consequence, the increase in the battery temperature can be suppressed.

A non-aqueous electrolyte secondary battery according to an embodiment of the present disclosure will now be described in detail.

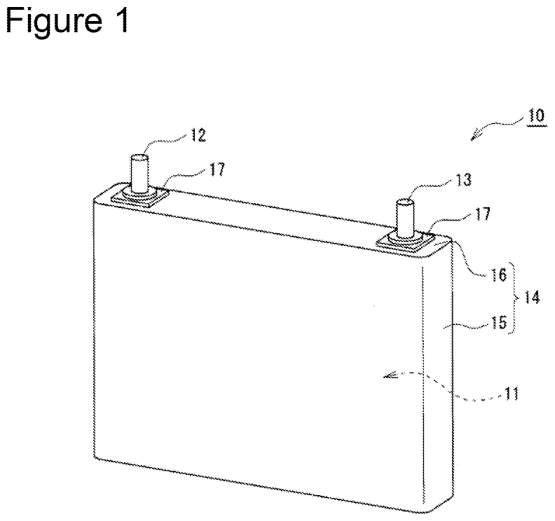

FIG. 1 is a perspective diagram showing a non-aqueous electrolyte secondary battery according to an embodiment of the present disclosure. A non-aqueous electrolyte secondary battery 10 comprises an electrode element 11, a non-aqueous electrolyte, and a rectangular battery casing 14 which houses the electrode element 11 and the non-aqueous electrolyte. The electrode element 11 comprises a positive electrode, a negative electrode, and a separator. The electrode element 11 is a layered-type electrode element in which a plurality of the positive electrodes and a plurality of the negative electrodes are alternately layered, one by one, with the separator therebetween. Alternatively, in place of the electrode element of the layered type, an electrode element of other forms may be employed such as a rolled-type electrode element in which the positive electrode and the negative electrode are rolled with the separator therebetween.

The battery casing 14 comprises a casing body 15 having an approximate box shape, a sealing element 16 which blocks an opening of the casing body 15, a positive electrode terminal 12 electrically connected to the positive electrode, and a negative electrode terminal 13 electrically connected to the negative electrode. The casing body 15 and the sealing element 16 are formed from a metal material, for example, having aluminum as a primary constituent. The positive electrode terminal 12 and the negative electrode terminal 13 are fixed to the sealing element 16 via an insulating member 17. In general, a gas discharging mechanism (not shown) is provided on the sealing element 16. The battery casing is not limited to the rectangular casing, and may alternatively be, for example, a metal casing of a form such as a circular cylindrical shape, a coin shape, a button shape, or the like, a resin casing (laminate) formed with resin films.

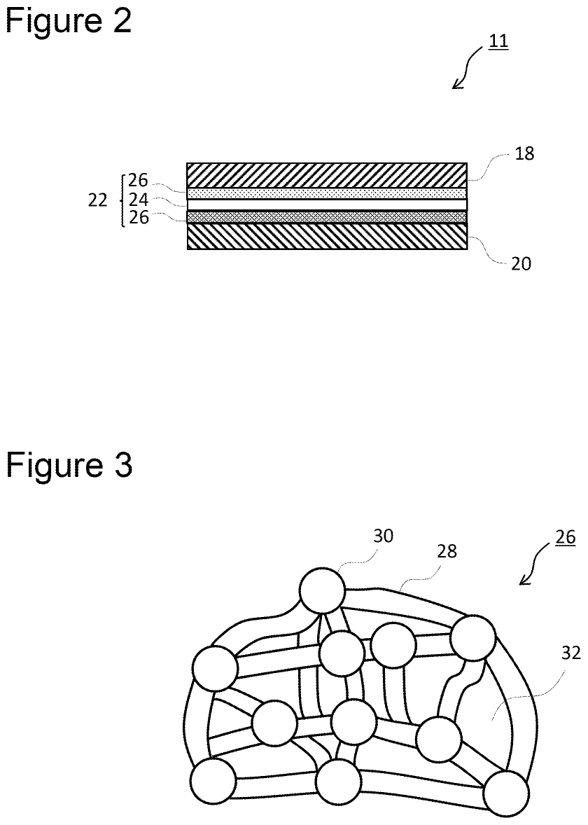

FIG. 2 is a partially enlarged cross-sectional view showing an example of an electrode element used in the non-aqueous electrolyte secondary battery of FIG. 1. The positive electrode, the negative electrode, and the separator will now be described with reference to FIG. 2.

### [Positive Electrode]

The positive electrode 18 comprises a positive electrode electricity collector element and a positive electrode mixture layer formed over the electricity collector element. For the positive electrode electricity collector element, there may be employed a foil of a metal which is stable within a potential range of the positive electrode 18 such as aluminum, a film on a surface layer of which the metal is placed, or the like. The positive electrode mixture layer includes, for example, a positive electrode active material, an electrically conductive material, and a binder material, and is desirably formed over both surfaces of the positive electrode electricity collector element. The positive electrode 18 can be produced by applying a positive electrode mixture slurry including the positive electrode active material, the electrically conductive material, the binder material, or the like over the positive electrode electricity collector element, drying the applied film, and rolling the dried film, to form the positive electrode mixture layer over both surfaces of the positive electrode electricity collector element. From the viewpoint of higher capacity of the battery, a density of the positive electrode mixture layer is greater than or equal to 3.6 g/cc, and is desirably greater than or equal to 3.6 g/cc and less than or equal to 4.0 g/cc.

As the positive electrode active material, a lithium-metal composite oxide containing metal elements such as Co, Mn, Ni, and Al may be exemplified. As the lithium-metal composite oxide, there may be exemplified LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, and Li₂MPO₄F (wherein M is at least one of Na, Mg, Sc, Y, Mn, Fe, Co, Ni, Cu, Zn, Al, Cr, Pb, Sb, and B, 0.95≤x≤1.2, 0.8≤y≤0.95, and 2.0≤z≤2.3).

As the electrically conductive material included in the positive electrode mixture layer, there may be exemplified carbon materials such as carbon black, acetylene black, Ketjen black, graphite, carbon nanotube, carbon nanofiber, graphene, or the like. As the binder material included in the positive electrode mixture layer, there may be exemplified a fluororesin such as polytetrafluoroethylene (PTFE), polyvinylidene fluoride (PVdF), polyacrylonitrile (PAN), polyimide, an acrylic resin, polyolefin, carboxy methyl cellulose (CMC) or a salt thereof, styrene-butadiene rubber (SBR), polyacrylic acid (PAA) or a salt thereof, polyvinyl alcohol (PVA), polyethylene oxide (PEO), or the like.

### [Negative Electrode]

The negative electrode 20 includes a negative electrode electricity collector element and a negative electrode mixture layer formed over the electricity collector element. For the negative electrode electricity collector element, a foil of a metal which is stable within a potential range of the negative electrode 20 such as copper, a film on a surface layer of which the metal is placed, or the like may be employed. The negative electrode mixture layer includes, for example, a negative electrode active material and a binder material, and is desirably formed over both surfaces of the negative electrode electricity collector element. The negative electrode 20 may be produced by applying a negative electrode mixture slurry including the negative electrode active material, the binder material, or the like over the negative electrode electricity collector element, drying the applied film, and rolling the dried film, to form the negative electrode mixture layer over both surfaces of the negative electrode electricity collector element.

As the negative electrode active material, no particular limitation is imposed so long as the material can reversibly occlude and release lithium ions. For example, carbon materials such as natural graphite, artificial graphite, or the like, a metal which forms an alloy with Li such as silicon (Si), tin (Sn), or the like, an oxide including a metal element such as Si, Sn, or the like, or a lithium-titanium composite oxide, or the like may be employed. When the lithium-titanium composite oxide is employed, an electrically conductive material such as the carbon black is desirably included in the negative electrode mixture layer. For the binder material included in the negative electrode mixture layer, materials similar to those of the positive electrode 18 may be employed.

### [Separator]

As exemplified in FIG. 2, the separator 22 includes a porous base member 24, and a filler layer 26 placed over the base member 24. The filler layer 26 includes phosphate particles, and inorganic particles having a higher heat endurance than the phosphate particles. In addition, the filler layer 26 desirably includes a binder material.

In the separator 22 shown in FIG. 2, the filler layer 26 is placed over both surfaces of the base member 24, but it is sufficient that the filler layer 26 be placed over one of the surfaces of the base member 24. The melting and the polycondensation of the phosphate particles included in the filler layer 26 may be caused not only by the heat when abnormality occurs in the battery, but also by a potential of the positive electrode 18 when the abnormality occurs in the battery. Therefore, from a viewpoint of a quick action of the shutdown function of the separator 22, desirably, the filler layer 26 is placed at least over the surface of the base member 24 opposing the positive electrode 18.

The base member 24 is formed from a porous sheet having an ion permeability and an insulating property such as, for example, a microporous thin film, a woven fabric, a non-woven fabric, or the like. As a resin forming the base member 24, there may be exemplified polyethylene, polypropylene, a polyolefin such as a copolymer of polyethylene and α-olefin, an acrylic resin, polystyrene, polyester, cellulose, or the like. The base member 24 is formed, for example, with polyolefin as a primary constituent, and may be formed substantially with polyolefin alone. The base member 24 may have a single layer structure, or a layered structure. No particular limitation is imposed on a thickness of the base member 24. The thickness is desirably, for example, greater than or equal to 3 μm and less than or equal to 20 μm.

A porosity of the base member 24 is desirably, for example, greater than or equal to 30% and less than or equal to 70%, in order to secure lithium ion permeability. The porosity of the base member 24 is measured by the following method.

(1) Ten locations of the base member are punched out in a circular shape with a diameter of 2 cm, and a thickness h and a mass w of a center part of a small piece of the base member which is punched out are measured.

(2) From the thickness h and the mass w, a volume V and a mass W of the ten small pieces are calculated, and the porosity c is calculated from the following equation.

Porosity ε(%)=((ρV−W)/(ρV))×100

where ρ is a density of a material of the base member.

An average pore size of the base member 24 is, for example, greater than or equal to 0.02 μm and less than or equal to 0.5 μm, and is desirably greater than or equal to 0.03 μm and less than or equal to 0.3 μm. The average pore size of the base member 24 is measured using a perm-porometer (manufactured by Seika Corporation) which can measure a small pore size by a bubble point method (JIS K3832, ASTM F316-86). The maximum pore size of the base member 24 is, for example, greater than or equal to 0.05 μm and less than or equal to 1 μm, and is desirably greater than or equal to 0.05 μm and less than or equal to 0.5 μm.

As the phosphate particles included in the filler layer 26, there may be exemplified Li₃PO₄, LiPON, Li₂HPO₄, LiH₂PO₄, Na₃PO₄, Na₂HPO₄, NaH₂PO₄, Zr₃(PO₄)₄, Zr(HPO₄)₂, HZr₂(PO₄)₃, K₃PO₄, K₂HPO₄, KH₂PO₄, Ca₃(PO₄)₂, CaHPO₄, Mg₃(PO₄)₂, MgHPO₄, or the like. Of these, from a viewpoint of suppression of a secondary reaction or the like, at least one compound selected from lithium phosphate (Li₃PO₄), dilithium hydrogenphosphate (Li₂HPO₄), and lithium dihydrogenphosphate (LiH₂PO₄) is desirably employed.

No particular limitation is imposed on the inorganic particles included in the filler layer 26, so long as the inorganic particles have a higher thermal endurance than the phosphate particles included in the filler layer 26 (that is, inorganic particles having a higher melting point than the phosphate particles), but the inorganic particles are desirably, for example, inorganic particles having a high electrical insulating property, from the viewpoint of suppressing occurrence of short-circuiting between the positive and negative electrodes. As the inorganic particles, for example, there can be exemplified metal oxides, metal oxide hydrates, metal hydroxides, metal nitrides, metal carbides, metal sulfides, or the like.

Examples of the metal oxides and the metal oxide hydrates include aluminum oxide (alumina), boehmite (Al₂O₃H₂O or AlOOH), magnesium oxide, titanium oxide, zirconium oxide, silicon oxide, yttrium oxide, zinc oxide, or the like. Examples of the metal nitrides include silicon nitride, aluminum nitride, boron nitride, titanium nitride, or the like. Examples of the metal carbides include silicon carbide, boron carbide, or the like. Examples of the metal sulfides include barium sulfate or the like. Examples of the metal hydroxides include aluminum hydroxide or the like. For a melting point of substances such as boehmite, for example, which melt after being altered to alumina, desirably, the melting point of the substance after the alteration is higher than the melting point of the phosphate particle.

Alternatively, the inorganic particle may be porous aluminosilicate such as zeolite (M_{2/n}O.Al₂O₃.xSiO₂.yH₂O, wherein M is a metal element, x≥2, and y≥0), a laminar silicate such as talc (Mg₃Si₄O₁₀(OH)₂), minerals such as barium titanate (BaTiO₃) and strontium titanate (SrTiO₃), or the like. In particular, from the viewpoints of the insulating characteristic, the thermal endurance, and the like, desirably, at least one compound selected from aluminum oxide, boehmite, talc, titanium oxide, and magnesium oxide is desirably employed.

It is sufficient that a BET specific surface area of the phosphate particles is greater than or equal to 5 m²/g and less than or equal to 100 m²/g, and is greater than a BET specific surface area of the inorganic particles, but the BET specific surface area is desirably greater than or equal to 20 m²/g and less than or equal to 80 m²/g. The BET specific surface area is measured according to a BET method (nitrogen adsorption method) of JIS R1626. In general, in consideration of the temperature required for production of a battery, an in-battery temperature during normal usage, and an in-battery temperature during abnormality, the phosphate particles desirably melt at a temperature of about 140° C. to about 190° C. The phosphate particle having the BET specific surface area within the above-described range easily melts at the temperature of about 140° C. to about 190° C. Thus, by using such a particle, the phosphates which melt and for which polycondensation occurs due to heat caused when the abnormality occurs in the battery can quickly fill the pores of the base member 24.

It is sufficient that the BET specific area of the inorganic particles be smaller than the BET specific surface area of the phosphate particles, and the BET specific area of the inorganic particles is desirably, for example, greater than or equal to 3 m²/g and less than or equal to 12 m²/g. By setting the BET specific surface area of the inorganic particles to be smaller than the BET specific surface area of the phosphate particles, and, desirably, to greater than or equal to 3 m²/g and less than or equal to 7 m²/g, a sufficient thermal endurance can be imparted to the filler layer 26.

It is sufficient that a volume-based 10% particle size (D₁₀) of the phosphate particles is greater than or equal to 0.02 μm and less than or equal to 0.5 μm and is smaller than an average pore size of the base member 24. Desirably, the volume-based 10% particle size is greater than or equal to 0.03 μm and less than or equal to 0.3 μm, and is smaller than the average pore size of the base member 24. When these ranges are satisfied, a portion of the phosphate particles easily penetrates into the pores of the base member 24 at the time of production of the separator 22, or the phosphate particles can quickly fill the pores of the base member 24 when the abnormality occurs in the battery. As a consequence, the increase in the battery temperature when the abnormality occurs in the battery can be effectively suppressed. A volume-based 10% particle size (D₁₀) of the inorganic particles is desirably greater than the volume-based 10% particle size (D₁₀) of the phosphate particles, for example, from the viewpoint of improving the thermal endurance of the filler layer 26, and is desirably, for example, greater than or equal to 0.3 μm. No particular limitation is imposed on an upper limit value, but the volume-based 10% particle size is, for example, 1 μm or less.

Here, the volume-based 10% particle size (D₁₀) refers to a particle size in which, in a particle size distribution of the phosphate particles or the inorganic particles, a volume accumulation value reaches 10%. A 50% particle size (D₅₀) and a 90% particle size (D₉₀) to be described later refer to particle sizes in which, in the particle size distribution, the volume accumulation value reaches 50% and 90%, respectively. The 50% particle size (D₅₀) is also called a median size. The particle size distribution of the phosphate particles or the inorganic particles is measured by a laser diffraction method (a laser diffraction-scattering granularity distribution measurement apparatus). In the following, unless otherwise noted, the 10% particle size, the 50% particle size, and the 90% particle size refer to the volume-based particle sizes.

The 50% particle size (D₅₀) of the phosphate particles is, for example, desirably greater than or equal to 0.05 μm and less than or equal to 1 μm, and is more desirably greater than or equal to 0.1 μm and less than or equal to 1 μm. When the 50% particle size (D₅₀) of the phosphate particles is out of these ranges, the advantage of suppression of the increase in the battery temperature when the abnormality occurs in the battery may be reduced in comparison to cases in which the 50% particle size is within these ranges. The 50% particle size (D₅₀) of the phosphate particles may be smaller than the average pore size of the base member 24. It is sufficient that a 50% particle size (D₅₀) of the inorganic particles be greater than the 50% particle size (D₅₀) of the phosphate particles, and the 50% particle size is desirably, for example, greater than or equal to 0.1 μm and less than or equal to 1 μm, and more desirably, greater than or equal to 0.2 μm and less than or equal to 0.8 μm. In this manner, by setting the 50% particle size (D₅₀) of the inorganic particles to be greater than the 50% particle size (D₅₀) of the phosphate particles, a sufficient thermal endurance may be imparted to the filler layer 26, and, consequently, the deformation and contraction of the base member 24 due to the heat can be effectively suppressed.

The 90% particle size (D₉₀) of the phosphate particles is desirably greater than the average pore size of the base member 24. The 90% particle size (D₉₀) is, for example, desirably greater than or equal to 0.2 μm and less than or equal to 2 μm, and is more desirably greater than or equal to 0.5 μm and less than or equal to 1.5 μm. When the D₉₀ is within these ranges, an amount of phosphate particles penetrating into the pores of the base member 24 at the time of production of the separator 22 can be adjusted in an appropriate range, and the increase in the battery temperature when the abnormality occurs in the battery can be effectively suppressed. A 90% particle size (D₉₀) of the inorganic particles is desirably, for example, greater than the volume-based 90% particle size (D₉₀) of the phosphate particles, and is desirably, for example, greater than or equal to 0.4 μm, from the viewpoint of improving the thermal endurance of the filler layer 26. No particular limitation is imposed on an upper limit value, but the 90% particle size is, for example, less than or equal to 1 μm.

A content of the phosphate particles in the filler layer 26 is desirably greater than or equal to 40 mass % and less than or equal to 80 mass %, and is more desirably greater than or equal to 50 mass % and less than or equal to 70 mass %, from the viewpoint of securing a sufficient amount for filling the pores of the base member 24. A content of the inorganic particles in the filler layer 26 is desirably greater than or equal to 10 mass % and less than or equal to 40 mass %, and is more desirably greater than or equal to 20 mass % and less than or equal to 40 mass %, from the viewpoint of improving the thermal endurance of the filler layer 26.

In the separator 22, a portion of the phosphate particles of the filler layer 26 penetrates into the pores of the base member 24, and an average value of a penetration depth of the particles is desirably greater than or equal to 0.02 μm and less than or equal to 2 μm, and is more desirably greater than or equal to 0.1 μm and less than or equal to 1.5 μm.

Here, the penetration depth of the phosphate particles refers to a length, along a thickness direction of the base member 24, from the surface of the base member 24 to an end of the particles which have penetrated into the base member 24. The penetration depth can be measured by a cross sectional observation of the base member 24 using a scanning electron microscope (SEM) or a transmission electron microscope (TEM).

The phosphate particles desirably penetrate into the pores over an approximately entire region of the surface of the base member 24. That is, the phosphate particles which have penetrated into the pores exist approximately uniformly over the surface of the base member 24. In addition, the penetration depth of the phosphate particles is desirably approximately uniform over an approximately entire region of the surface of the base member 24.

An average value of the penetration depth of the phosphate particles is, for example, greater than or equal to 1% and less than or equal to 50% with respect to the thickness of the base member 24, and is desirably greater than or equal to 5% and less than or equal to 30%. By adjusting the 10% particle size (D₁₀) of the phosphate particles or the like according to the average pore size of the base member 24, it becomes possible to control the depth of the phosphate particles penetrating into the base member 24.

When the filler layer 26 is provided over both surfaces of the base member 24, a total thickness of the filler layer 26 (thickness other than the penetration depth of the phosphate particles) is desirably, for example, less than or equal to 6 μm, is more desirably greater than or equal to 1 μm and less than or equal to 6 μm, and is particularly desirably greater than or equal to 1 μm and less than or equal to 4 μm. A thickness of one filler layer 26 is, for example, desirably less than or equal to 4 μm, and is more desirably greater than or equal to 0.5 μm and less than or equal to 2 μm.

A porosity of the filler layer 26 is desirably greater than or equal to 30% and less than or equal to 70%, from the viewpoints of securing a superior ion permeability during charging or discharging of the battery, of securing a physical strength, and the like. The porosity of the filler layer 26 is calculated by the following equation.

Porosity of filler layer(%)=100−[[W÷(d×ρ)]×100]

where W is a mass per unit area of the filler layer (g/cm²), d is a thickness of the filler layer (cm), and ρ is an average density of the filler layer (g/cm³).

The filler layer 26 desirably includes a binder material from the viewpoint of improving a mechanical strength, an adhesion property, or the like of the layer. As the binder material, for example, there may be exemplified polyethylene, poly propylene, a polyolefin such as a copolymer of polyethylene and α-olefin, a fluororesin such as PVdF, PTFE, and polyvinyl fluoride (PVF), a fluorine-containing rubber such as a copolymer of vinylidene fluoride-hexafluoropropylene-tetrafluoroethylene, and a copolymer of ethylene-tetrafluoroethylene, a copolymer of styrene-butadiene and a hydride thereof, a copolymer of acrylonitrile-butadiene and a hydride thereof, a copolymer of acrylonitrile-butadiene-styrene and a hydride thereof, a copolymer of ester methacrylate-ester acrylate, a copolymer of styrene-ester acrylate, a copolymer of acrylonitrile-ester acrylate, polyvinyl acetate, polyphenylene ether, polysulfone, polyether sulfone, polyphenylene sulfide, polyether imide, polyamideimide, polyamide, poly N-vinyl acetamide, polyester, polyacrylonitrile, cellulose, a copolymer of ethylene-vinyl acetate, polyvinyl chloride, isoprene rubber, butadiene rubber, methyl polyacrylate, ethyl polyacrylate, polyvinyl alcohol, CMC, acrylamide, PVA, methyl cellulose, guar gum, sodium alginate, carrageenan, and xanthan gum, and salts thereof. Of these materials, poly N-vinyl acetamide and a polyvinylidene fluoride-based resin are desirable from the viewpoint of the adhesion property or the like, and a polyvinylidene fluoride-based resin in a mesh form is more desirable from the viewpoint of the adhesion property with the electrode, the ion permeability, or the like.

FIG. 3 is a partially enlarged plan view of the filler layer for explaining a state of the polyvinylidene fluoride of the mesh form. As shown in FIG. 3, polyvinylidene fluoride-based resins 28 of the mesh form of the filler layer 26 are in a fiber form and are three-dimensionally connected to each other to form a mesh-form network. The fiber form means a state in which a ratio (aspect ratio) of a length (fiber length) to a radius (fiber radius) is 3 or greater. Particles 30 (the phosphate particles and the inorganic particles) of the filler layer 26 are fixed by the mesh-form network of the polyvinylidene fluoride-based resin 28. This filler layer 26 has multiple pores 32, and has a structure in which the pores 32 are connected to each other. Because of this, in the filler layer 26, lithium ions can easily pass through from one surface to the other surface. In addition, the filler layer 26 has an adhesive property with the electrode (the positive electrode 18 or the negative electrode 20) due to an anchoring effect of the polyvinylidene fluoride-based resin 28 of the mesh form at the surface thereof. During the adhesion of the electrode and the filler layer 26, for example, desirably, press is applied in a layering direction of the electrode element 11 at a normal temperature or at a warm temperature. In the filler layer 26 shown in FIG. 3, a part of the surface of the particle 30 (the phosphate particle or the inorganic particle) is covered by the polyvinylidene fluoride-based resin 28, but from the viewpoint of adhesion property with the electrode, desirably, an entirety of the surface of the phosphate particle is covered with the polyvinylidene fluoride-based resin 28. More desirably, an entirety of the surface of the phosphate particle and an entirety of the surface of the inorganic particle are covered with the polyvinylidene fluoride-based resin 28.

For the polyvinylidene fluoride-based resin, desirably, there is employed a single polymer of vinylidene fluoride (that is, polyvinylidene fluoride), a copolymer of the vinylidene fluoride and another copolymerizable monomer, or a mixture of these. For the monomer copolymerizable with the vinylidene fluoride, there can be employed one or two or more of tetrafluoroethylene, hexafluoropropylene, trifluoroethylene, vinyl fluoride, or the like. The polyvinylidene fluoride-based resin desirably contains the vinylidene fluoride serving as a constituting unit in greater than or equal to 70 mass %, and more desirably in greater than or equal to 80 mass %, from the viewpoint of adhesion property with the electrode. Further, the polyvinylidene fluoride-based resin desirably contains hexafluoropropylene serving as a constituting unit in greater than or equal to 3 mass % and less than or equal to 15 mass %, from the viewpoint of the adhesion property with the electrode or the like.

The binder material in the filler layer 26 is, for example, greater than or equal to 2 mass % and less than or equal to 8 mass %.

When the polyvinylidene fluoride-based resin of the mesh form is used as the binder material, the content of the polyvinylidene fluoride-based resin in the filler layer 26 is desirably greater than or equal to 15 mass % and less than or equal to 40 mass %, and is more desirably greater than or equal to 15 mass % and less than or equal to 25 mass %, in consideration of the adhesion property with the electrode or the like. When the content of the polyvinylidene fluoride-based resin in the filler layer 26 is less than 15 mass %, the adhesion property with the electrode is reduced, and there is a possibility that the opposition of the positive electrode and the negative electrode may be deviated. On the other hand, when the content of the polyvinylidene fluoride-based resin in the filler layer 26 exceeds 40 mass %, for example, the thermal endurance and strength of the separator may be reduced due to a reduction of the filler in the filler layer 26.

The filler layer 26 may further include heteropoly acid. It can be deduced that, by adding the heteropoly acid, polycondensation of the melted phosphates may be promoted. As the heteropoly acid, there may be exemplified phosphomolybdic acid, phosphotungstic acid, phosphomolybdotungstic acid, phosphomolybdovanadic acid, phosphomolybdotungstovanadic acid, phosphotungstovanadic acid, tungstosilisic acid, molybdosilisic acid, molybdotungstosilisic acid, and molybdotungstovanadosilisic acid.

The filler layer 26 is formed, for example, by applying a slurry including phosphate particles, inorganic particles, optional binder material, or the like over a surface of the base member 24, and drying the applied film. Alternatively, a slurry including, for example, the phosphate particle, the inorganic particle, the polyvinylidene fluoride-based resin, and a dispersion medium may be applied over the surface of the base member 24, the resulting structure may be passed through a non-solvent or a mixture solvent of the non-solvent and the dispersion medium to extract the dispersion medium (phase separation), and then a phase separation method may be applied to dry the resulting structure, to form the filler layer 26. With such a phase separation method, a filler layer 26 may be formed including the phosphate particles, the inorganic particles, and the polyvinylidene fluoride-based resin of the mesh form. The slurry may be applied by any conventionally known method such as gravure printing or the like.

The non-solvent used in the phase separation method is a solvent in which almost no polyvinylidene fluoride-based resin dissolves, and there may be exemplified, for example, water, alcohols, ethers, or the like. The dispersion medium is a solvent in which the polyvinylidene fluoride-based resin dissolves, and there may be exemplified, for example, N-methyl-2-pyrrolidone, N,N-dimethylformamide, N,N-dimethylacetamide or the like. When water is used as the non-solvent, desirably, N,N-dimethylacetamide is used, from the viewpoint of quickness of an extraction rate of the dispersion medium.

The penetration depth of the phosphate particles into the pores of the base member 24 can be controlled through the particle size of the phosphate particles, a drying condition of the applied film of the slurry, a method of application of the slurry, or the like. For example, when the 10% particle size (D₁₀) of the phosphate particles is reduced or when the drying condition of the applied film is set milder, it becomes easier for the phosphate particles to penetrate into the base member 24. In addition, when a rotational speed of a gravure roll used for the application of the slurry is decreased, it becomes easier for the phosphate particles to penetrate into the base member 24.

### [Non-Aqueous Electrolyte]

The non-aqueous electrolyte includes a non-aqueous solvent and an electrolyte salt dissolved in the non-aqueous solvent. The non-aqueous electrolyte is not limited to a liquid electrolyte (non-aqueous electrolyte solution), and may alternatively be a solid electrolyte using a gel-form polymer or the like. For the non-aqueous solvent, for example, esters, ethers, nitriles such as acetonitrile, amides such as dimethylformamide, or a mixture solvent of two or more of these solvents may be employed. The non-aqueous solvent may include a halogen substitution product in which at least a part of hydrogens of the solvent described above is substituted with a halogen atom such as fluorine.

Examples of the esters include cyclic carbonic acid esters such as ethylene carbonate (EC), propylene carbonate (PC), and butylene carbonate, chain carbonic acid esters such as dimethyl carbonate (DMC), ethylmethyl carbonate (EMC), diethyl carbonate (DEC), methylpropyl carbonate, ethylpropyl carbonate, and methylisopropyl carbonate, cyclic carboxylate esters such as γ-butyrolactone (GBL) and γ-valerolactone (GVL), and chain carboxylate esters such as methyl acetate, ethyl acetate, propyl acetate, methyl propionate (MP), ethyl propionate, and γ-butyrolactone.

Examples of the ethers include cyclic ethers such as 1,3-dioxolane, 4-methyl-1,3-dioxolane, tetrahydrofuran, 2-methyl tetrahydrofuran, propylene oxide, 1,2-butylene oxide, 1,3-dioxane, 1,4-dioxane, 1,3,5-trioxane, furan, 2-methyl furan, 1,8-cineol, and crown ether, and chain ethers such as 1,2-dimethoxy ethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxy toluene, benzyl ethyl ether, diphenyl ether, dibenzyl ether, o-dimethoxy benzene, 1,2-diethoxy ethane, 1,2-dibutoxy ethane, diethylene glycol dimethyl ether, diethylene glycol diethyl ether, diethylene glycol dibutyl ether, 1,1-dimethoxy methane, 1,1-diethoxy ethane, triethylene glycol dimethyl ether, and tetraethylene glycol dimethyl ether.

As the halogen substitution product, desirably, fluorinated cyclic carbonic acid esters such as fluoroethylene carbonate (FEC), fluorinated chain carbonic acid ester, or fluorinated chain carboxylate esters such as fluoromethyl propionate (FMP) is employed.

The electrolyte salt is desirably a lithium salt. Examples of the lithium salt include LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), LiPF₆₋ₓ(CₙF₂ₙ₊₁)ₓ (wherein 1<x<6, n is 1 or 2), LiB₁₀Cl₁₀, LiCl, LiBr, LiI, lithium chloroborane, lithium lower aliphatic carboxylate, borate salts such as Li₂B₄O₇ and Li(B(C₂O₄)F₂), and imide salts such as LiN(SO₂CF₃)₂, and LiN(CₗF₂ₗ₊₁SO₂)(CₘF₂ₘ₊₁SO₂) (wherein each of l and m is an integer greater than or equal to 0). As the lithium salt, these materials may be used as a single material or a mixture of a plurality of these materials may be used. Of these, LiPF₆ is desirably used, from the viewpoints of ion conductivity, electrochemical stability, or the like. A concentration of the lithium salt is desirably set to 0.8˜1.8 mol per 1 L of the non-aqueous solvent.

### EXAMPLES

The present disclosure will now be further described with reference to Examples. The present disclosure, however, is not limited to these Examples.

### Example 1

### [Production of Separator]

A separator having a three-layer structure of a filler layer/a porous base member made of polyethylene/a filler layer was produced through the following process.

### (1) Preparation of Slurry

Lithium phosphate particles (Li₃PO₄) having a BET specific surface area of 61.3 m²/g, a D₁₀ of 0.091 μm, and a D₅₀ of 0.17 μm, alumina (Al₂O₃) having a BET specific surface area of 4.3 m²/g, a D₁₀ of 0.35 μm, and a D₅₀ of 0.46 μm, and a polyvinylidene fluoride-based resin (including 5 mass % of hexafluoropropylene) were mixed with a mass ratio of 46:46:8, and N-methyl-2-pyrrolidone (NMP) was added, to prepare a slurry.

### (2) Formation of Filler Layer

Over one surface of a polyethylene porous base member of a single layer with a thickness of 12 μm, the above-described slurry was applied, and the structure was dried at 60° C. for 6 minutes, to form the filler layer over the one surface of the base member. Through a similar operation, the filler layer was formed also over the other surface of the base member. An average pore size of the polyethylene porous base member was 0.5 μm.

### [Production of Positive Electrode]

As the positive electrode active material, a lithium-composite oxide particle was used which is represented by Li_{1.05}Ni_{0.82}Co_{0.15}Al_{0.03}O₂. The positive electrode active material, carbon black, and PVdF were mixed in NMP with a mass ratio of 100:1:1, to prepare a positive electrode mixture slurry. Then, the positive electrode mixture slurry was applied over both surfaces of a positive electrode electricity collector element formed from an aluminum foil, the applied film was dried and rolled by a rolling roller, and an aluminum electricity collector tab was attached, to produce a positive electrode in which the positive electrode mixture layer was formed over both surfaces of the positive electrode electricity collector element. A filling density of the positive electrode mixture was 3.70 g/cm³.

### [Production of Negative Electrode]

Artificial graphite, sodium carboxymethyl cellulose (CMC-Na), and a dispersion of styrene-butadiene rubber (SBR) were mixed in water with a solid content mass ratio of 98:1:1, to prepare a negative electrode mixture slurry. Then, the negative electrode mixture slurry was applied over both surfaces of a negative electrode electricity collector element formed from a copper foil, the applied film was dried and rolled with a rolling roller, and a nickel electricity collector tab was attached, to form a negative electrode in which a negative electrode mixture layer was formed over both surfaces of the negative electrode electricity collector element. A filling density of the negative electrode mixture was 1.70 g/cm³.

### [Preparation of Non-Aqueous Electrolyte]

To a mixture solvent in which ethylene carbonate (EC), ethylmethyl carbonate (EMC), and dimethyl carbonate (DMC) were mixed with a volume ratio of 3:3:4, lithium hexafluorophosphate (LiPF₆) was dissolved in a concentration of 1 mol/liter. Further, vinylene carbonate (VC) was dissolved in the mixture solvent in a concentration of 1 mass %, to prepare a non-aqueous electrolyte.

### [Production of Non-Aqueous Electrolyte Secondary Battery]

The negative electrode and the positive electrode were alternately layered with the separator therebetween, to produce a layered-type electrode element. The electrode element was pressed in the layering direction, and was housed in a rectangular battery casing along with the non-aqueous electrolyte, to produce a rectangular test cell of 750 mAh.

### Example 2

Anon-aqueous electrolyte secondary battery was produced in a manner similar to Example 1 except that, in the preparation of the slurry, alumina (Al₂O₃) was used having the BET specific surface area of 10.3 m²/g, the D₁₀ of 0.15 μm, and the D₅₀ of 0.2 μm.

### Example 3

Anon-aqueous electrolyte secondary battery was produced in a manner similar to Example 1 except that, in the preparation of the slurry, lithium phosphate particles (Li₃PO₄) were used having the BET specific surface area of 6.5 m²/g, the D₁₀ of 0.42 μm, and the D₅₀ of 0.7 μm.

### Comparative Example 1

A non-aqueous electrolyte secondary battery was produced in a manner similar to Example 1 except that, in the preparation of the slurry, lithium phosphate particles (Li₃PO₄) were used having the BET specific surface area of 3.3 m²/g, the D₁₀ of 0.68 μm, and the D₅₀ of 1.15 μm.

### Comparative Example 2

Anon-aqueous electrolyte secondary battery was produced in a manner similar to Example 1 except that, in the formation of the filler layer, lithium phosphate particles (Li₃PO₄) were used having the BET specific surface area of 8 m²/g, the D₁₀ of 0.52 μm, and the D₅₀ of 0.72 μm.

### Comparative Example 3

Anon-aqueous electrolyte secondary battery was produced in a manner similar to Example 1 except that, in the formation of the filler layer, lithium phosphate particles (Li₃PO₄) were used having the BET specific surface area of 5.2 m²/g, the D₁₀ of 0.36 μm, and the D₅₀ of 0.65 μm.

### [Nail Penetration Test]

The batteries of Examples and Comparative Examples were charged under an environment of 25° C. with a constant current of 225 mA until the battery voltage reached 4.2V, and then, were charged at a constant voltage of 4.2V until the current value became 37.5 mA. Under an environment of 25° C., a wire nail having a size of 1 mmφ was penetrated in the layering direction of the electrode element at a rate of 0.1 mm/second through a center part of a side surface of the battery in the above-described charge state, and the nail penetration was stopped when the nail completely penetrated through the battery. A battery temperature at a location 5 mm distanced from the side surface portion of the battery through which the wire nail was penetrated was measured, and a maximum reaching temperature was determined. TABLE 1 shows the results.

TABLE 1

| | SEPARATOR | | | | | | |
|---|---|---|---|---|---|---|---|
| | | | | INORGANIC PARTICLES | | | |
| | PHOSPHATE PARTICLES | | | (ALUMINA) | | | |
| | 10% | 50% | | 10% | 50% | | BATTERY PROPERTY |
| | PARTICLE | PARTICLE | | PARTICLE | PARTICLE | | MAXIMUM REACHING |
| | SIZE | SIZE | BET | SIZE | SIZE | BET | TEMPERATURE |
| | (μm) | (μm) | (m²/g) | (μm) | (μm) | (m³/g) | (° C.) |
| EXAMPLE 1 | 0.091 | 0.17 | 61.3 | 0.35 | 0.46 | 4.3 | 434 |
| EXAMPLE 2 | 0.091 | 0.17 | 61.3 | 0.15 | 0.2 | 10.3 | 440 |
| EXAMPLE 3 | 0.42 | 0.7 | 6.5 | 0.35 | 0.46 | 4.3 | 444 |
| COMPARATIVE | 0.68 | 1.15 | 3.3 | 0.35 | 0.46 | 4.3 | 461 |
| EXAMPLE 1 | | | | | | | |
| COMPARATIVE | 0.52 | 0.72 | 8 | 0.35 | 0.46 | 4.3 | 456 |
| EXAMPLE 2 | | | | | | | |
| COMPARATIVE | 0.36 | 0.65 | 5.2 | 0.35 | 0.46 | 4.3 | 465 |
| EXAMPLE 3 | | | | | | | |

All of Examples 1 to 3 had a lower maximum reaching temperature in the nail penetration test than Comparative Examples 1 to 3. Thus, the increase in the battery temperature when the abnormality occurs in the battery was suppressed in Examples. Here, because the test was a test for a testing battery, although layered-type batteries were employed, the adhesive property between the separator and the electrode was not imparted. When the battery is to be mass-produced as a product, adhesion is necessary. In this case, as described earlier, an adhesion function layer may be separately provided, or a filler layer including the polyvinylidene fluoride-based resin of the mesh form may be desirably employed.

### REFERENCE SIGNS LIST

10 NON-AQUEOUS ELECTROLYTE SECONDARY BATTERY; 11 ELECTRODE ELEMENT; 12 POSITIVE ELECTRODE TERMINAL: 13 NEGATIVE ELECTRODE TERMINAL; 14 BATTERY CASING; 15 CASING BODY; 16 SEALING ELEMENT; 17 INSULATING MEMBER; 18 POSITIVE ELECTRODE; 20 NEGATIVE ELECTRODE; 22 SEPARATOR; 24 BASE MEMBER; 26 FILLER LAYER; 28 POLYVINYLIDENE FLUORIDE-BASED RESIN; 30 PARTICLE; 32 PORE.

1. A non-aqueous electrolyte secondary battery comprising:
an electrode element having a positive electrode, a negative electrode, and a separator; and
a non-aqueous electrolyte, wherein
the separator comprises a porous base member, and a filler layer placed over the base member, the filler layer includes phosphate particles and inorganic particles having a higher thermal endurance than the phosphate particles,
a volume-based 10% particle size (D₁₀) of the phosphate particles is greater than or equal to 0.02 μm and less than or equal to 0.5 μm, and is smaller than an average pore size of the base member,
a BET specific surface area of the phosphate particles is greater than or equal to 5 m²/g and less than or equal to 100 m²/g, and is greater than a BET specific surface area of the inorganic particles, and
a volume-based 50% particle size (D₅₀) of the inorganic particles is greater than a volume-based 50% particle size (D₅₀) of the phosphate particles.

2. The non-aqueous electrolyte secondary battery according to claim 1, wherein
a portion of the phosphate particles penetrates into a pore of the base member, and
an average value of a penetration depth of the particles is greater than or equal to 0.02 μm and less than or equal to 2 μm.

3. The non-aqueous electrolyte secondary battery according to claim 1 or 2, wherein
a thickness of the filler layer is less than or equal to 4 μm.

4. The non-aqueous electrolyte secondary battery according to claim 1, wherein
the filler layer includes a polyvinylidene fluoride-based resin of a mesh form, and
a content of the polyvinylidene fluoride-based resin in the filler layer is greater than or equal to 15 mass % and less than or equal to 40 mass %.

5. The non-aqueous electrolyte secondary battery according to claim 4, wherein
an entirety of a surface of the phosphate particle is covered by the polyvinylidene fluoride-based resin.

6. The non-aqueous electrolyte secondary battery according to claim 4, wherein
the polyvinylidene fluoride-based resin includes hexafluoropropylene in an amount of greater than or equal to 3 mass % and less than or equal to 15 mass %.
